(19) United States
(12) Patent Application Publication
(10) Pub. No.: US 2014/0278908 A1
(43) Pub. Date: Sep. 18, 2014

(54) EXPERIMENTATION AND VALIDATION OF DYNAMIC PLAYBOOK FOR SOCIAL CHANNELS

(71) Applicant: WETPAINT.COM, INC., Seattle, WA (US)

(72) Inventors: Peter Raymond Ondish, Saegertown, PA (US); Alex David Weinstein, Bellevue, WA (US)

(73) Assignee: WETPAINT.COM, INC., Seattle, WA (US)

(21) Appl. No.: 13/797,452

(22) Filed: Mar. 12, 2013

(51) Int. Cl. G06Q 30/02

(52) U.S. Cl. CPC G06Q 30/0242
USPC 705/14.41

(57) ABSTRACT

Embodiments are directed towards dynamically managing contextual recommendations that can be employed with content when provided to a channel. A test for a variable having at least two outcomes may be determined to be employed with selected content. Each outcome may correspond to a different contextual recommendation. Each selected content may be published to the channel at least twice, where a portion of the selected content may be initially published based on a contextual recommendation corresponding to a first outcome and later republished based on another contextual recommendation corresponding to the second outcome, and a separate portion of the selected content may be initially published based on the other contextual recommendation corresponding to the second outcome and later republished based on the contextual recommendation corresponding to the first outcome. A preferred outcome for the test may be determined based on user actions associated with the published selected content.

### TECHNICAL FIELD

The present invention relates generally to content management, and more particularly, but not exclusively, to dynamically experimenting with multiple contextual recommendations to employ with content to determine preferred contextual recommendations.

### BACKGROUND

Today, many brands provide content to their audience through one or more channels. These channels range from email distribution lists to social media web pages. Sometimes, brands may provide different content to different audiences. However, audiences may vary widely in their preferences for how content is provided to them. For example, one audience may prefer an image with the content, while another audience may prefer no image. If an audience has a preference for images, but the brand does not provide images, then the audience may lose interest in the brand. As a result, the uninterested reader may turn to a different a different brand and/or media property in the future. Accordingly, the way in which content is provided to an audience and the preferences of that audience can impact an engagement level of the audience; referral and/or retention rates; return on investment, or the like. It is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical flow diagram generally showing one embodiment of an overview process for providing content to a channel based on a determined test and associated outcomes;

FIG. 5 illustrates a logical flow diagram generally showing one embodiment of a process for publishing content based on a plurality of outcomes of a test;

FIG. 6 illustrates a logical flow diagram generally showing one embodiment of a process for determining a preferred outcome of a test; and

FIG. 7 illustrates a logical flow diagram generally showing one embodiment of a process for validating a playbook employed for a channel.

### DETAILED DESCRIPTION

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “content” refers to digital data that may be communicated over a network to be remotely displayed by a computing device. Non-exhaustive examples of content include but are not limited to articles, blogs, movies, videos, music, sounds, pictures, illustrations, graphics, images, text, or the like. Content may also include summaries, briefs, snippets, headlines, or the like, of the content. In at least one embodiment, content may also include links, hyperlinks, or the like, to additional content. For example, a piece of content may be a post to a social media page, where the post includes a heading and a link to an article.

In some embodiments, each piece of content may include one or more features of the content. These features may include, for example, a subject, topic, theme, type of content, content form (e.g., new report, investigation report, breaking news report, editorial piece, opinion piece, or the like), trend, character, person, topic, keyword, date of creation, author, publisher/poster, or the like. Features may also include content structure indicators, such as, for example, presence and/or number of questions directed at the audience, presence and/or number of emotional statements, headline form (e.g., statement, question, emotional statement, or the like), or the like. In at least one of various embodiments, the features of a piece of content may also include traffic achieved for the content on a channel (i.e., a channel that the content is posted/provided), which may include statistics and other information about the content, such as, for example, amount of editing time, publication date and/or time, time a visitor accesses the content, number of online “hits” that he content receives (e.g., number of clicks, click rate, or the like), virality (e.g., number of shares), engagement of users (e.g., number of comments), exit rate from page, or the like.

Features may also include an aspect, characteristic, and/or substance of a piece of content that can be modified. In at least one embodiment, features may indicate how the content should be displayed to a user. For example, in some embodiments, the feature may indicate a format of the content, such as, for example, font color, font size, capitalization utilization, image size, image quality, or the like. However, in other embodiments, the features may indicate whether or not to include an image, whether an audience poll is including with the content, whether the content should be provided in the form of a question, or the like. In another embodiment, the features may indicate a keyword to include with the content, such as, for example, “breaking news,” “just in,” or the like. These keywords may also include a name associated with the content, such as person discussed in the content, a show/episode title, article title, or the like.

As used herein, the term “channel” refers to a method of providing and/or otherwise distributing content from a publisher to a user. Channels may include, but are not limited to, email messages, text messages, web pages, social media pages, social media messages, physical medium including mailings, billboard displays, television, telephone calls, or the like. Non-limiting, non-exhaustive examples of providing content to a user through a channel may include posting content or a link to content on a social media page, sending an email with content to a user, or the like. In some embodiments, users may subscribe to a channel by requesting content from a publisher through a channel, by signing up with a channel (e.g., signing up with an email distribution list), becoming a member of the channel (e.g., becoming a member of the publisher's social media page), or the like. Subscribing to a channel may be free or may include a monetary cost, which may be charged to a user and/or offset by advertising. In some embodiments, content may be posted and/or otherwise provided to a channel for one or more users. In other embodiments, content may be provided through a channel to one or more users.

As used herein, the term “test,” “contextual recommendation test,” and/or “test for a variable” may refer to an operation employed to determine a preferred outcome from a plurality of outcomes. Each outcome of a test may correspond to a different contextual recommendation that can be employed with a piece of content. A preferred outcome may be an outcome of a test (after that test was employed with a plurality of different pieces of content) that performed better than another outcome, achieved more positive results than another outcome, or the like. In at least one embodiment, the test may be in the form on an A/B test with outcome_A and outcome_B, also referred to as a first outcome and second outcome, respectively.

As used herein, the phrase “contextual recommendation” may refer to an aspect, characteristic, and/or substance of a piece of content that can be modified. In some embodiments, contextual recommendations may be provided to a social marketer, which may be utilized to employ the contextual recommendation. In at least one embodiment, contextual recommendations may indicate how the content should be displayed to a user. For example, in some embodiments, the contextual recommendation may indicate a format of the content, such as, for example, font color, font size, capitalization utilization, image size, image quality, or the like. However, in other embodiments, the contextual recommendation may indicate whether or not to include an image, whether an audience poll is including with the content, whether the content should be provided in the form of a question, or the like. In another embodiment, the contextual recommendations may indicate a keyword to include with the content, such as, for example, “breaking news,” “just in,” or the like. These keywords may also include a name associated with the content, such as person discussed in the content, a show/episode title, article title, or the like. In some embodiments, employing a contextual recommendation for a piece of content may include modifying a feature of that piece of content.

As used herein, the term “playbook” may refer to a list of one or more plays. A “play” or “marketing play,” as used herein, may refer to an outcome and/or a preferred outcome determined from a test. In at least one embodiment, a play may be a preferred contextual recommendation that may be utilized to modify a piece of content for publishing to a given channel and/or a plurality of channels. In another embodiment, a play may indicate which of a plurality of channels to provide a piece of content (e.g., through a social media page, by email distribution, or the like). In some embodiments, different playbooks may be generated and/or determined for different channels. In other embodiments, one or more playbooks may be generated for a plurality of channels, which may be referred to as a multi-channel playbook.

As used herein, the terms “success” and/or “overall success” may refer to a metric and/or value that indicates how successful a piece of content and/or feature is for a given objective function. The objective function may be a test for determining how well content performs based on monitored actions associated with the content. These actions may include, but are not limited to, a number of user clicks, a number of times users' share the content, a number of user comments, a time accessing the content and/or the containing channel, revenue obtained from advertising associated with the content (e.g., advertisements shown alongside the content), revenue obtained directly from the user, or the like. In at least one embodiment, the actions may be monitored and/or collected for a given period of time.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to dynamically managing contextual recommendations that can be employed with content when the content is provided to a channel Since content can be provided to users in a plurality of different ways, from font colors to keywords, to sentence structure, and the like, it may be beneficial to determine which ways perform better than others for different groups of users. Typical A/B testing creates two versions of the same content, where each version is provided to different subsets of users. However, many channels, especially social networking channels, do not enable publishers to control multiple versions of content and/or control which users see which version of content. Various embodiments described herein are directed towards employing at least one test for a variable having at least two outcomes, such that each of a plurality of selected content is separately published multiple times, each time employing a different outcome.

In some embodiments, a plurality of tests can be generated. Each test may include a plurality of different outcomes, where each outcome may correspond to a different contextual recommendation. Tests can be generated and employed for specific audiences, for content that has specific features, for specific channels, or the like. For example, one test may be employed to determine whether red font or green font is preferred by users that access content regarding sports, while another test may be employed to determine whether a particular audience prefers images as part of the content or not. In some other embodiments, a test can be employed for multiple different channels and/or audiences.

A plurality of content may be selected to be provided to a plurality of users through a channel for distribution of content. A test may be determined for each piece of content. Based on the determined test, each piece of content may be published to the channel at least twice, once based on a contextual recommendation corresponding to a first outcome of the test, and once based on another contextual recommendation corresponding to a second outcome of the test. In some embodiments, a portion of the selected content may be initially published based on the contextual recommendation and later republished based on the other contextual recommendation, and a separate portion of the selected content may be initially published based on the other contextual recommendation and later republished based on the contextual recommendation.

A preferred outcome from the first outcome and the second outcome may be determined based on user actions associated with the published selected content. In at least one of various embodiments, the preferred outcome may be determined from the first outcome and the second outcome based on a depreciation of user actions associated with a first publication of the selected content and other user actions associated with a second publication of the selected content. In some embodiments, a preferred outcome may be determined for a plurality of channels from the first outcome and the second outcome based on user actions associated with published content on a subset of the plurality of channels.

In some embodiments, a plurality of preferred contextual recommendations (i.e., a playbook) may be determined for a plurality of channels for distribution. In some embodiments, each preferred contextual recommendation may be determined based on different preferred outcomes determined from different tests. Content may be published to the plurality of channels based on at least one of a plurality of preferred contextual recommendations. In some embodiments, a metric may be determined for each of the plurality of preferred contextual recommendations employed for publishing content to each of the plurality of channels. In at least one such embodiment, each preferred contextual recommendation that corresponds to a metric for a corresponding channel that is above a threshold may be employed for publication of other content to the corresponding channels. In other embodiments, for each given channel of the plurality of channels, a metric may be determined for each of the plurality of preferred contextual recommendations employed for publishing content to the given channel. Based on these determined metrics that are above and/or below a threshold, the plurality of contextual recommendations for the given channel may be modified based on the determined metrics. For example, preferred contextual recommendation metrics for a particular channel below the threshold may be removed from the preferred contextual recommendations for that particular channel.

### Illustrative Operating Environment

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client devices 102-105, Content Management Server Device (CMSD) 112, Social Distribution Server Device (SDSD) 114, and Test Management Server Device (TMSD) 116.

At least one embodiment of client devices 102-105 is described in more detail below in conjunction with FIG. 2. In one embodiment, at least some of client devices 102-105 may operate over a wired and/or wireless network, such as networks 110 and/or 108. Generally, client devices 102-105 may include virtually any computing device capable of communicating over a network to send and receive information, perform various online activities, offline actions, or the like. In one embodiment, one or more of client devices 102-105 may be configured to operate within a business or other entity to perform a variety of services for the business or other entity. For example, client devices 102-105 may be configured to operate as a web server, an accounting server, a production server, an inventory server, or the like. However, client devices 102-105 are not constrained to these services and may also be employed, for example, as an end-user computing node, in other embodiments. It should be recognized that more or less client devices may be included within a system such as described herein, and embodiments are therefore not constrained by the number or type of client devices employed.

Devices that may operate as client device 102 may include devices that typically connect using a wired or wireless communications medium such as personal computers, multiprocessor systems, microprocessor-based or programmable electronic devices, network PCs, or the like. In some embodiments, client devices 102-105 may include virtually any portable personal computing device capable of connecting to another computing device and receiving information such as, laptop computer 103, smart mobile telephone 104, and tablet computers 105, and the like. However, portable computing devices are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client devices 102-105 typically range widely in terms of capabilities and features. Moreover, client devices 102-105 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client device may employ the browser application to perform various activities over a network (online) However, another application may also be used to perform various online activities.

Client devices 102-105 also may include at least one other client application that is configured to receive and/or send content between another computing device. The client application may include a capability to send, receive, and/or otherwise access content, or the like. The client application may further provide information that identifies itself, including a type, capability, name, and the like. In one embodiment, client devices 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client devices, SDSD 114, or other computing devices.

Client devices 102-105 may further be configured to include a client application that enables an end-user to log into an end-user account that may be managed by another computing device, such as SDSD 114, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client devices 103-105 and its components with network 110. Wireless network 108 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client devices 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client devices 103-105 and another computing device, network, and the like.

Network 110 is configured to couple network devices with other computing devices, including, CMSD 112, SDSD 114, TMSD 116, client device 102, and client devices 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

One embodiment of CMSD 112 is described in more detail below in conjunction with FIG. 3. Briefly, however, CMSD 112 includes virtually any network device capable of managing a plurality of content. In at least one embodiment, CMSD 112 may manage individual pieces of content. In some embodiments, CMSD 112 may manage and/or store which channel(s) the content has been provided/published. In other embodiments, CMSD 112 may monitor and/or collect actions provided by users on the content, such as a number of clicks, user comments, or the like. In some embodiments, CMSD 112 may be enabled to analyze the monitored actions to determine one or more successes and/or metrics associated with the content for an objective function. CMSD 112 may store the determined successes and/or metrics for the content. Examples of successes may include, but is not limited to, a number of times the content was accessed by a user, how long a user accessed the content, whether a user shared the content, features of the content, comments and/or posts provided by users about the content, or the like.

Devices that may be arranged to operate as CMSD 112 include various network devices, including, but not limited to personal computers, desktop computers, multiprocessor systems, microprocessor-based or programmable consumer electronics, network PCs, server devices, network appliances, and the like.

Although FIG. 1 illustrates CMSD 112 as a single computing device, the invention is not so limited. For example, one or more functions of the CMSD 112 may be distributed across one or more distinct network devices. Moreover, CMSD 112 is not limited to a particular configuration. Thus, in one embodiment, CMSD 112 may contain a plurality of network devices. In another embodiment, CMSD 112 may contain a plurality of network devices that operate using a master/slave approach, where one of the plurality of network devices of CMSD 112 operates to manage and/or otherwise coordinate operations of the other network devices. In other embodiments, the CMSD 112 may operate as a plurality of network devices within a cluster architecture, a peer-to-peer architecture, and/or even within a cloud architecture. Thus, the invention is not to be construed as being limited to a single environment, and other configurations, and architectures are also envisaged.

One embodiment of SDSD 114 is described in more detail below in conjunction with FIG. 3. Briefly, however, SDSD 114 includes virtually any network device capable of posting, publishing, and/or otherwise providing content to a channel. SDSD 114 may be enabled to communicate with CMSD 112. In at least one embodiment, SDSD 114 may receive content from CMSD 112. In some embodiments, SDSD 114 may monitor and/or collect actions provided by users on the content, such as a number of clicks, user comments, or the like. In some embodiments, SDSD 114 may be enabled to analyze the monitored actions to determine one or more metrics about a test/outcome associated with a piece of content. In at least one embodiment, SDSD 114 may provide the monitored actions and/or the determined metrics to CMSD 112 for storage.

In some embodiments, SDSD 114 may determine which test may be employed with a piece of content. In other embodiments, SDSD 114 may enable a marketing administrator to select, add, and/or modify content based on the outcomes (i.e., the contextual recommendations). In at least one embodiment, SDSD 114 may be enabled to communicate with TMSD 116 to access tests and/or corresponding outcomes. In some other embodiments, SDSD 114 may schedule and/or re-schedule tests to be employed with content.

Devices that may be arranged to operate as SDSD 114 include various network devices, including, but not limited to personal computers, desktop computers, multiprocessor systems, microprocessor-based or programmable consumer electronics, network PCs, server devices, network appliances, and the like.

Although FIG. 1 illustrates SDSD 114 as a single computing device, the invention is not so limited. For example, one or more functions of the SDSD 114 may be distributed across one or more distinct network devices. Moreover, SDSD 114 is not limited to a particular configuration. Thus, in one embodiment, SDSD 114 may contain a plurality of network devices. In another embodiment, SDSD 114 may contain a plurality of network devices that operate using a master/slave approach, where one of the plurality of network devices of SDSD 114 operates to manage and/or otherwise coordinate operations of the other network devices. In other embodiments, the SDSD 114 may operate as a plurality of network devices within a cluster architecture, a peer-to-peer architecture, and/or even within a cloud architecture. Thus, the invention is not to be construed as being limited to a single environment, and other configurations, and architectures are also envisaged.

One embodiment of TMSD 116 is described in more detail below in conjunction with FIG. 3. Briefly, however, TMSD 116 includes virtually any network device capable of creating, storing, deleting, and/or otherwise managing one or more tests and their associated outcomes. In at least one embodiment, TMSD 116 may store and/or generate metrics associated with each test based on monitored actions (e.g., by SDSD 114).

Devices that may be arranged to operate as TMSD 116 include various network devices, including, but not limited to personal computers, desktop computers, multiprocessor systems, microprocessor-based or programmable consumer electronics, network PCs, server devices, network appliances, and the like.

Although FIG. 1 illustrates TMSD 116 as a single computing device, the invention is not so limited. For example, one or more functions of the TMSD 116 may be distributed across one or more distinct network devices. Moreover, TMSD 116 is not limited to a particular configuration. Thus, in one embodiment, TMSD 116 may contain a plurality of network devices.

In another embodiment, TMSD 116 may contain a plurality of network devices that operate using a master/slave approach, where one of the plurality of network devices of TMSD 116 operates to manage and/or otherwise coordinate operations of the other network devices. In other embodiments, the TMSD 116 may operate as a plurality of network devices within a cluster architecture, a peer-to-peer architecture, and/or even within a cloud architecture. Thus, the invention is not to be construed as being limited to a single environment, and other configurations, and architectures are also envisaged.

Although illustrated separately, the functionality of CMSD 112, SDSD 114, and TMSD 116 may be performed by a single device, different devices, different combinations of devices, or the like.

### Illustrative Client Device

FIG. 2 shows one embodiment of client device 200 that may be included in a system implementing embodiments of the invention. Client device 200 may include many more or less components than those shown in FIG. 2. However, the components shown are sufficient to disclose an illustrative embodiment for practicing the present invention. Client device 200 may represent, for example, one embodiment of at least one of client devices 102-105 of FIG. 1.

As shown in the figure, client device 200 includes a processor 202 in communication with a mass memory 226 via a bus 234. In some embodiments, processor 202 may include one or more central processing units (CPU). Client device 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to client device 200. A rechargeable or non-rechargeable battery may be used to provide power. The power may also be provided by an external power source, such as an alternating current (AC) adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client device. For example, the haptic interface 250 may be employed to vibrate client device 200 in a particular way when another user of a computing device is calling. In some embodiments, haptic interface 250 may be optional.

Client device 200 may also include GPS transceiver 232 to determine the physical coordinates of client device 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, data storage 208 may also store message, web page content, or any of a variety of user generated content. At least a portion of the information may also be stored on another component of network device 200, including, but not limited to processor readable storage media 230, a disk drive or other computer readable storage devices (not shown) within client device 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computing device. Processor readable storage media 230 may also be referred to herein as computer readable storage media and/or computer readable storage device.

Applications 214 may include computer executable instructions which, when executed by client device 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client device. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, other content, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client device 200 to communicate with another network device, such as CMSD 112, SDSD 114, and/or TMSD 116 of FIG. 1.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, a host, or any other device. Network device 300 may represent, for example CMSD 112, SDSD 114, TMSD 116 of FIG. 1—a combination of those devices—and/or other network devices.

Network device 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network device 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network device 300. Any general-purpose operating system may be employed. Basic input/output system (BIOS) 324 is also provided for controlling the low-level operation of network device 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 326 further includes one or more data storage 308, which can be utilized by network device 300 to store, among other things, applications 314 and/or other data. For example, data storage 308 may also be employed to store information that describes various capabilities of network device 300. The information may then be provided to another device based on any of a variety of events, including being sent as part of a header during a communication, sent upon request, or the like. Data storage 308 may also be employed to store messages, web page content, or the like. At least a portion of the information may also be stored on another component of network device 300, including, but not limited to processor readable storage media 328, hard disk drive 334, or other computer readable storage medias (not shown) within client device 300.

Data storage 308 may include a database, text, spreadsheet, folder, file, or the like, that may be configured to maintain and store user account identifiers, user profiles, email addresses, IM addresses, and/or other network addresses; or the like. Data storage 308 may further include program code, data, algorithms, and the like, for use by a processor, such as processor 302 to execute and perform actions. In one embodiment, at least some of data store 308 might also be stored on another component of network device 300, including, but not limited to processor-readable storage media 328, hard disk drive 334, or the like.

Data store 308 may also include content 310 and tests 312. Content 310 may include a plurality of pieces of content. In some embodiments, content 310 may include other data associated with each piece of content, such as, for example, a history of actions performed by users on the content, a test employed with the content, features of the content, to what channel was the content published, or the like. In some embodiments, each piece of content may also include an indication and/or identifier of which test outcome was employed for a first publication and which test outcome was employed for a second publication (e.g., was an experimental outcome employed when the content was first published to a channel or was a control outcome employed when the content was first published to the channel). In at least one embodiment content may be associated with a unique identifier. In some embodiments, the unique identifier may be utilized to obtain and/or store actions associated with the content.

Tests 312 may include a plurality of tests. In some embodiments, tests 312 may include currently executing tests, historical tests that are not currently being executed, schedule of tests to be executed, metrics associated with a test, or the like. In some embodiments, the test may be performed for one or more different channels (e.g., a subset of a plurality of channels).

Applications 314 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 314 may also include website server 318, Content Management Server (CMS) 319, Social Distribution Server (SDS) 320, and Test Management Server (TMS) 321.

Website server 318 may represents any of a variety of information and services that are configured to provide content, including messages, over a network to another computing device. Thus, website server 318 can include, for example, a web server, a File Transfer Protocol (FTP) server, a database server, a content server, or the like. Website server 318 may provide the content including messages over the network using any of a variety of formats including, but not limited to WAP, HDML, WML, SGML, HTML, XML, Compact HTML (cHTML), Extensible HTML (xHTML), or the like.

CMS 319 may be configured to manage a plurality of content, such as content 310. In at least one embodiment CMS 319 may manage content as described above in conjunction with CMSD 112 of FIG. 1. In some embodiments, CMS 319 may be employed by CMSD 112 of FIG. 1. In any event, CMS 319 may employ processes, or parts of processes, similar to those described in conjunction with FIGS. 4-6, to perform at least some of its actions.

SDS 320 may be configured to enable a user to view and select features for generating new content, as described above in conjunction with SDSD 114 of FIG. 1. In some embodiments, SDS 320 may be enabled to employ tests with content, provide content to channels, monitor actions associated with the content, or the like. In at least one embodiment, these actions may be detected by a third party or a dedicated web server, which may produce reports of the actions associated with a piece of content (as identified by a unique identifier). In other embodiments, SDS 320 may calculate and/or determine metrics for each outcome of each of a plurality of tests. In some embodiments, SDS 320 may be employed by SDSD 114 of FIG. 1. In any event, SDS 320 may employ processes, or parts of processes, similar to those described in conjunction with FIGS. 4-6 to perform at least some of its actions.

TMS 321 may be configured to manage a plurality of tests, such as test 312. In at least one embodiment, TMS 321 may manage tests as described above in conjunction with TMSD 116 of FIG. 1. In some embodiments, TMS 321 may be employed by TMSD 116 of FIG. 1. In any event, TMS 321 may employ processes, or parts of processes, similar to those described in conjunction with FIGS. 4-6 to perform at least some of its actions.

### General Operation

The operation of certain aspects of the invention will now be described with respect to FIGS. 4-7. In at least one of various embodiments, processes 400, 500, 600, and 700 described in conjunction with FIGS. 4-7, respectively, may be implemented by and/or executed on a single network device, such as network device 300 of FIG. 3. In other embodiments, these processes or portions of process thereof may be implemented by and/or executed on a plurality of network devices, such as network device 300 of FIG. 3. However, embodiments are not so limited and various combinations of network devices, or the like, may be utilized.

FIG. 4 illustrates a logical flow diagram generally showing one embodiment of an overview process for providing content to a channel based on a determined test and associated outcomes. Process 400 begins, after a start block, at block 402, where a channel to publish content may be selected and/or otherwise determined. In some embodiments, process 400 may be employed for a single channel and/or for a plurality of channels. In at least one of various embodiments, process 400 may be separately employed for each of a plurality of channels. For example, process 400 may be employed for content published to Channel_{—}1 and separately employed for content published to Channel_{—}2. Such separate employment can enable the determination of separate preferred outcomes of a same test for different channels.

In some embodiments, the channel may be automatically selected or manually selected by a publisher, editor, audience development staff, marketing team, or the like. In other embodiments, the channel may be randomly selected from a plurality of channels. In yet other embodiments, the channel may be selected based on content to be provided and/or published to a user/audience. So in some embodiment, the content may be selected (at block 404) before the channel is selected.

In any event, process 400 continues at block 404, where a piece of content may be selected. In at least one embodiment, the content may be selected by a publisher, editor, audience development staff, marketing team, or the like. In some embodiments, the content may be selected from a plurality of different possible content that may be provided to a user (also referred to herein as a reader and/or audience). For example, a plurality of possible content may include, but is not limited to, “today's top stories,” content regarding breaking news, most popular content among readers, editorially-curated content of special importance, randomly selected content, or the like.

In at least one embodiment, content may be selected when it is generated and/or created. In another embodiment, content may be selected randomly, at predetermined times, at periodic time intervals, or the like. For example, in one embodiment, two pieces of content may be selected per channel per day. In some embodiments, process 400 may be employed for a plurality of content that may be provided to users, such that each piece of content may be selected at block 402.

In some embodiments, selection of a piece of content may also include selection of one or more channels for providing the content. In at least one embodiment, process 400 may be separately employed for one or more different channels. In various embodiments, the channel may be determined based on one or more features associated with the selected content. In at least one embodiment, each channel may include one or more characteristics about a corresponding channel. In some embodiments, the characteristics may describe the content associated with a channel. For example, a channel may be characterized as “United States economy”, which may indicate that a majority of the content posted to the channel include the feature “United States economy.” In at least one of various embodiments, the characteristics of a channel may be compared to the features of the selected content to determine if the content may be provided to that channel.

Process 400 proceeds next to block 406, where a test for a variable may be determined. In at least one embodiment, each piece of content (e.g., each post) may employ a test. In at least one embodiment, the test for the variable may have and/or include a plurality of outcomes. In at least one of various embodiments, the test may be an A/B test having a first outcome (e.g., outcome_A) and a second outcome (e.g., outcome_B), where the A/B test may assess which outcome is preferred over the other outcome. In some embodiments, one outcome may be referred to as the control and the other outcome may be referred to as the experiment.

In various embodiments, the first outcome and second outcome may be two possible outcomes (although there could be more) of the determined test, but, in some embodiments, may not indicate an order for which an outcome is employed with a piece of content for publishing and/or republished. So, in some embodiments, a first publication outcome (either the first outcome of the test or the second outcome of the test) may be an outcome employed with a piece of content when the content is initially published, and a second publication outcome (the first outcome of the test or the second outcome of the test, whichever outcome is not employed as the first publication outcome) may be an outcome employed with the same piece of content when the content is republished at a later date/time. For example, in at least one embodiment, the first outcome may be initially employed with content and the second outcome may be employed with the same content at a later date/time. In another embodiment, the second outcome may be initially employed with content and the first outcome may be employed with the same content at a later date/time.

As described above, each outcome of a test may indicate how a piece of content should be provided to a user, e.g., a contextual recommendation that can be employed with a piece of content. In some embodiments, the outcomes of a test may be determined and/or defined by, for example, a publisher, marketing administrator, or the like. Outcomes can include a variety of different ways to display and/or provide content to users. Examples of outcomes include, but are not limited to, capitalize words in a headline, include the word “you” or other keywords in teaser text, include a poll in the teaser text, include a question in the headline, employ a specific font color/size, include an image, employ a specific image size/quality, or the like, or any combination thereof. In some embodiments, the outcomes of a test may be determined/created by a publisher, marketing administrator, or the like. In other embodiments, the outcomes of a test may be automatically determined/created based on monitored actions of previously provided content. For example, the monitored actions may utilize click counts to indicate words, phrases, formats, or other contextual recommendations to include as outcomes.

In at least one of various embodiments, the test may be randomly selected from a plurality of different tests for other variables. In some embodiments, each of the plurality of different tests may have a plurality of outcomes. An outcome of one test may be exclusive to that test or may be common to one or more other tests. In other embodiments, each test may identify one or more predetermined channels, groups of users, or the like, to determine when to employ the test. For example, one test may be employed with content provided to a sports channel, while another test may be employed with content provided to a political channel or a breaking news channel.

In some embodiments, the test may be determined based on channels associated with the test and channels associated/selected with the selected content. For example, if the content is associated with a sports channel, then a test that may be employed on a sports channel may be selected. In other embodiments, the test may be determined based on one or more features of the content. For example, if the content includes the feature breaking news, then a test that may be employed on breaking news content may be selected. However, embodiments are not so limited and other methods for determining which of a plurality of tests to employ. For example, in other embodiments, tests may be selected based on a time of day when the content is to be provided to the channel. In yet other embodiments, the test may be employed for one or more groups of users (i.e., audiences).

In some other embodiments, a plurality of tests may be employed for the selected piece of content. In at least one such embodiment, an outcome for each test may be determined at block 406, as described below.

In any event, process 400 proceeds next to block 408, which is described in more detail below in conjunction with FIG. 5. Briefly, however, the selected content may be published to the selected channel at least twice, a separate publication of the selected content for each outcome of the test. In at least one of various embodiments, the selected content may be initially published based on an outcome of the test (i.e., first publication) and, at a later date and/or time, the selected content may be republished based on another outcome of the test (i.e., second publication). In some embodiments, the selected content may separately be republished for each outcome.

Process 400 continues at decision block 410, where a determination may be made whether or not to select other content. In some embodiments, this determination may be based on the test size and the current test sample size (i.e., the number of previously selected pieces of content). In at least one embodiment, if the current test sample size is less than the test size then another piece of content may be selected; otherwise, no more content may be selected. If another piece of content may be selected, then process 400 may loop to block 404; otherwise, process 400 may flow to block 412.

At block 414, a preferred outcome may be determined based on actions associated with a plurality of content, which is described in more detail below in conjunction with FIG. 6. Briefly, however, the preferred outcome of the test may be determined from the at least two outcomes of the test based on a comparison of metrics for each of the at least two outcomes. In some embodiments, the preferred outcome may be referred to as best practices to employ with content (e.g., for content with features that are the same or similar to features of content that employed the test). In at least one embodiment, actions associated with each of a plurality of content may be analyzed to determine the metric for each outcome associated with the test.

After block 412, process 400 may return to a calling process to perform other actions.

Although process 400 is described with reference to content, embodiments are not so limited; but rather, process 400 may also be employed for features of content (e.g., known features and/or unknown/unclassified features). For example, at block 404, a feature may be selected; at block 406, a test may be determined for the selected feature; at block 408, content that includes the selected feature may be published for each outcome of the test (e.g., a same piece of content or different content with the same features); and at block 412, a preferred outcome may be determined based on actions associated with a plurality of content that includes the selected features.

FIG. 5 illustrates a logical flow diagram generally showing one embodiment of a process for publishing content based on a plurality of outcomes of a test. In some embodiments, process 500 may be separately employed for each content selected in process 400 of FIG. 4.

Process 500 begins, after a start block, at block 502, where an order to employ test outcomes may be determined. The order to employ test outcomes may be the order in which content is published based on an outcome. For example, assume the test has two outcomes. When content is initially published (i.e., first publication), the content may be published based on an outcome of the test (i.e., first publication outcome). At a later date/time, the content may be republished (i.e., second publication) based on a different and/or separate outcome of the test (i.e., second publication outcome).

In some embodiments, the order to employ outcomes for a given piece of content may be randomly determined and/or selected from the outcomes associated with the test, such as a first outcome or a second outcome (noting that first outcome and second outcome may not indicate an order for being employed). In at least one embodiment, the outcome selected for the first publication may be randomly selected such that a number of times (or number of different pieces of content) that each outcome associated with the test is selected as the first publication outcome is substantially similar.

In some embodiments, the order may be the first outcome then the second outcome, such that the first publication outcome is the first outcome and the second publication outcome is the second outcome. In other embodiments, the order may be the second outcome then the first outcome, such that the first publication outcome is the second outcome and the second publication outcome is the first outcome. As indicated above, one of the outcomes of a test may be a control and the other may be an experiment. So, in at least one embodiment, the order may be the control then the experiment, such that the first publication outcome is the control and the second publication outcome is the experiment. In other embodiments, the order may be the experiment then the control, such that the first publication outcome is the experiment and the second publication outcome is the control.

In any event, process 500 proceeds to decision block 504, where a determination may be made whether the first publication outcome is based on a first outcome of the test. In at least one embodiment, this determination may be based on the determined order to employ the test outcomes. If the first publication outcome is based on the first outcome, then process 500 may proceed to block 506; otherwise, process 500 may proceed to block 510.

At block 506, the content (e.g., the selected content of block 404 of FIG. 4) may be published to the channel (e.g., the selected channel of block 402 of FIG. 4) based on the first outcome of the test (e.g., the determined test of block 406 of FIG. 4). In at least one embodiment, this publication may be referred to as the first publication or an initial publication of the content.

In at least one of various embodiments, the content may be published to the channel based on a first contextual recommendation corresponding to the first outcome. In some embodiments, the content may be modified based on the first contextual recommendation. In at least one embodiment, the content may be modified to include the first outcome. For example, if the first outcome indicates that a keyword should be included in the content, then the content may be modified to include the keyword.

Process 500 proceeds next to block 508, where the content may be provided and/or published to the channel based on the second outcome of the test. In at least one embodiment, the second outcome may be another outcome that is different and/or separate from the first outcome. In some embodiments, the content may be republished to the channel based on the second outcome. In at least one embodiment, this publication may be referred to as the second publication or subsequent publication of the content. In some embodiments, the second publication may be two days, one week, two weeks, or other time period, after the first publication.

In at least one embodiment, the content may be published/republished to the channel based on another or second contextual recommendation corresponding to the second outcome. In some embodiments, the content may be published based on the second outcome (e.g., the second contextual recommendation corresponding to the second outcome) independent of the first outcome (i.e., the first contextual recommendation corresponding to the first outcome). In other embodiments, the content may be modified based on the second contextual recommendation corresponding to the second outcome. In at least one embodiment, the content may be modified to include the second outcome.

After block 508, process 500 may return to a calling process to perform other actions.

If, at decision block 504, the first publication outcome is not based on the first outcome (i.e., the first publication outcome is based on the second outcome), then process 500 may flow from decision block 504 to block 510. At block 510, the content may be published to the channel based on the second outcome of the test. In at least one embodiment, this publication may be referred to as the first publication or an initial publication of the content.

In at least one of various embodiments, the content may be published to the channel based on the second contextual recommendation corresponding to the second outcome (which may be similar or the same as the second contextual recommendation described at block 508). In some embodiments, the content may be modified based on the second contextual recommendation corresponding to the second outcome. In at least one embodiment, the content may be modified to include the second outcome.

Process 500 proceeds next to block 512, where the selected content may be provided and/or published to the channel based on the first outcome of the test. In at least one embodiment, the first outcome may be another outcome that is different and/or separate from the second outcome. In some embodiments, the content may be republished to the channel based on the first outcome. In at least one embodiment, this publication may be referred to as the second publication or subsequent publication of the content. In some embodiments, the second publication may be two days, one week, two weeks, or other time period, after the first publication.

In at least one embodiment, the content may be published/republished to the channel based on a first contextual recommendation corresponding to the first outcome (which may be similar or the same as the first contextual recommendation described at block 506). In some embodiments, the content may be published based on the first outcome (e.g., the first contextual recommendation corresponding to the first outcome) independent of the second outcome (i.e., the second contextual recommendation corresponding to the second outcome). In other embodiments, the content may be modified based on the first contextual recommendation. In at least one embodiment, the content may be modified to include the second outcome.

After block 512, process 500 may return to a calling process to perform other actions.

Although process 500 is described with reference to content, embodiments are not so limited; but rather, process 500 may also be employed for features of content. For example, at block 506, content with a selected feature may be initially published to the channel based on a first outcome of the test; at block 508, content with the selected feature may be republished to the channel based on a second outcome of the test; at block 510, content with the selected feature may be initially published to the channel based on the second outcome of the test; and at block 512, content with the selected feature may be republished to the channel based on the first outcome of the test.

FIG. 6 illustrates a logical flow diagram generally showing one embodiment of a process for determining a preferred outcome of a test. Process 600 begins, after a start block, at block 602, where actions associated with a plurality of content for a test may be monitored. In some embodiments, the actions may include those actions performed by users on the content, such as, for example, accessing the content (e.g., clicking on the content), providing a comment, sharing the content, accessing the content for more than a threshold amount of time, or any combination thereof, or the like. In some embodiments, the actions associated with a particular test may be monitored for a predetermined period of time. In at least one embodiment, the period of time may be based on a time it takes a current test sample size to reach a test size (e.g., a minimum number of pieces of content that employ a test). For example, if two pieces of content are provided to the channel per day, then it may take five days to reach a test size of 10.

Process 600 continues at block 604, where a plurality of content may be selected. The selected content may be content with a first publication based on the first outcome of the test (i.e., the first publication outcome is the first outcome and the second publication outcome is the second outcome).

Process 600 proceeds to block 606, where metrics for the first outcome as the first publication outcome and the second outcome as the second publication outcome may be determined. In at least one embodiment, two separate metrics may be determined, one for the first outcome as the first publication outcome and another for the second outcome as the second publication outcome. Both of these metrics may be a numerical value, an n-tuple, a qualitative assessment, and/or an indicator of a success/impact/performance that an outcome had on the content.

In various embodiments, the metric for an outcome may be determined based on actions associated with the selected content that employed the outcome. In some embodiments, the metric may be a total number of actions performed on the selected content. In other embodiments, the metric may be an average number of actions performed on the selected content for a predetermined time period (e.g., 100 clicks per day). In yet other embodiments, the metric may be an average number of actions performed on each piece of content of the selected content (e.g., 20 clicks per piece of content). However, embodiments are not so limited and other methods and/or algorithms for calculating metrics for an outcome may be employed.

So, in some embodiments, there may be a different metric determined for each outcome—such as a first metric for when the selected content was initially published and a second metric for when the selected content was later republished. In various embodiments, these metrics may be determined based on actions associated with content that was published based on an outcome independent of a substance of the outcome. For example, if the outcomes are to include a photo or not to include a photo, the metric may be determined independent of the substance of the photo.

For example, assume the test is to determine whether or not to include a photo. The first outcome may be with a photo and the second outcome may be without a photo. At block 604 content may be selected that was initially published with a photo and later republished without a photo. Assume for this example, that the metric is based on the average number of user clicks per hour for a two week time period. At block 606, the determined metrics may indicate that when content is initially published with the photo there are 200 clicks per hour, but 100 clicks per hour when the same content is republished without the photo.

Process 600 proceeds next to block 608, where a first depreciation may be calculated. In some embodiments, the first depreciation may be the different between the determined metrics. In at least one embodiment, the metric for the second outcome as the second publication outcome may be subtracted from the metric for the first outcome as the first publication outcome. Continuing the example above, the first depreciation may be equal to 100 clicks per hour (200 clicks per hour minus 100 clicks per hour). However, embodiments are not so limited and other algorithms may be employed to calculate a depreciation between the metrics of the multiple publications of the content.

In any event, process 600 continues at block 610, where another plurality of content may be selected. The other selected content may be content with a first publication based on the second outcome of the test (i.e., the first publication outcome is the second outcome and the second publication outcome is the first outcome).

Process 600 proceeds to block 612, where metrics for the second outcome as the first publication outcome and the first outcome as the second publication outcome may be determined. In at least one of various embodiments, block 612 may employ embodiments of block 606 to determine metrics for an outcome.

Continuing the example described at block 606, at block 610, other content may be selected that was initially published without a photo and later republished with a photo. At block 612, the determined metrics may indicate that when content is initially published without a photo there are 180 clicks per hour, but 140 clicks per hour when the same content is republished with a photo.

Process 600 continues at block 614, where a second depreciation may be calculated. In at least one of various embodiments, block 614 may employ embodiments of block 608 to calculate the depreciation. Continuing the example above, the second depreciation may be equal to 40 clicks per hour (180 clicks per hour minus 140 clicks per hour). However, embodiments are not so limited and other algorithms may be employed to calculate a depreciation between the metrics of the multiple publications of the content.

Process 600 proceeds next to block 616, where a preferred outcome may be determined based on the first depreciation and the second depreciation. In some embodiments, a difference between the two depreciations may be determined, which may indicate whether there is a statistical significance between the depreciations (e.g., there may be a statistical significance if the difference is above a threshold value). In at least one embodiment, determining which of the outcomes may be the preferred outcome may be based on the lesser of the two depreciations.

In some embodiments, the preferred outcome may be determined based on a difference between the first depreciation and the second depreciation being above a predetermined threshold. In some embodiments, the threshold may be based on a statistical significance analysis and/or t-test. In at least one of the various embodiments, the first depreciation may include a first distribution of change between the first outcome and the second outcome; and the second depreciation may include a second distribution of change between the second outcome and the first outcome. In some embodiments, these distributions may be compared and to determine if there is a statistical significance between the two outcomes.

In at least one embodiment, a t-test may be employed for each distribution and the difference between the two t-tests may be determined. If the difference is above a threshold, then one of the outcomes may be determined as the preferred outcome. In at least one such embodiment, if the difference between the two distributions is above a threshold and if the lesser of the two depreciations is the first depreciation then the preferred outcome may be second outcome. In another such embodiment, if the difference between the two distributions is above a threshold and if the lesser of the two depreciations is the second depreciation then the preferred outcome may be the first outcome.

In some embodiments, determining which of the outcomes may be the preferred outcome may be based on the lesser of the two depreciations. In at least one embodiment, the second publication outcome associated with the lesser depreciation may be determined to be the preferred outcome. So, if the lesser of the two depreciations is the first depreciation then the preferred outcome may be second outcome, and if the lesser of the two depreciations is the second depreciation then the preferred outcome may be the first outcome. In other embodiments, the first publication outcome associated with a greater depreciation may be determined to be the preferred outcome. However, embodiments are not so limited and other algorithms and/or mechanisms may be employed to determine a preferred outcome.

For example, in some other embodiments, the preferred outcome may be determined based on a comparison of combined metrics for a same outcome. For example, both metrics for the first outcome may be combined (e.g., the average number of clicks on content published based on the first outcome, regardless of publication order with other outcomes) and both metrics for the second outcome may be combined (e.g., the average number of clicks on content published based on the second outcome, regardless of publication order with other outcomes). These metrics may be referred to as a combined first outcome metric and a combined second outcome metric, respectively. If the combined first outcome metric is greater than the combined second outcome metric, then the preferred outcome may be the first outcome, and if the combined second outcome metric is greater than the combined first outcome metric, then the preferred outcome may be the second outcome. As described above, to be a preferred outcome, the difference between these combined metrics may be above a threshold (e.g., a statistically significant threshold).

In yet other embodiments, the above described depreciations may be compared to a base-line depreciation for an outcome. For example, a base-line depreciation for a first outcome may be calculated by employing embodiments described herein, where content is both initially published and subsequently published based on the first outcome. Similarly, a base-line depreciation for a second outcome may be calculated by employing embodiments described herein, where content is both initially published and subsequently published based on the second outcome.

The first depreciation and the second depreciation (as determined at blocks 608 and 614) may be compared to these base-line depreciations to determine a preferred outcome. The following are example embodiments for determining the preferred outcome based on these comparisons. In at least one embodiment, if the first depreciation is less than both base-line depreciations for the first and second outcomes, then the preferred outcome may be the second outcome. In another embodiment, if the second depreciation is less than both base-line depreciations for the first and second outcomes, then the preferred outcome may be the first outcome. In yet another embodiment, if the first depreciation is greater than both base-line depreciations for the first and second outcomes, then the preferred outcome may be the first outcome. In still another embodiment, if the second depreciation is greater than both base-line depreciations for the first and second outcomes, then the preferred outcome may be the second outcome.

In other embodiments, if the first depreciation is greater than the base-line depreciation for the first outcome and less than the base-line depreciation for the second outcome, then the preferred outcome may be the first outcome. In at least one embodiment, if the first depreciation is less than the base-line depreciation for the first outcome and greater than the base-line depreciation for the second outcome, then the preferred outcome may be the second outcome. In another embodiment, if the second depreciation is greater than the base-line depreciation for the first outcome and less than the base-line depreciation for the second outcome, then the preferred outcome may be the first outcome. In yet another embodiment, if the second depreciation is less than the base-line depreciation for the first outcome and greater than the base-line depreciation for the second outcome, then the preferred outcome may be the second outcome.

The above embodiments for determining a preferred outcome are not to be construed as limiting but rather, other mechanisms and/or algorithms may be employed to determine a preferred outcome based on actions associated with the published content.

In some embodiments, the determined preferred outcome may be a preferred outcome for the channel that the corresponding test was employed on. In other embodiments, the determined preferred outcome may be a preferred outcome for a plurality of channels (e.g., a multi-channel preferred outcome and/or a preferred contextual recommendation). In at least one embodiment, a preferred outcome of one or more channels may be a multi-channel preferred outcome if the same preferred outcome is determined for threshold number of channels for a same test. For example, assume a test is to determine whether or not to include a photo. If the test is employed on four of 20 channels and each test resulted in a preferred outcome of with a photo, then the outcome with a photo may be determined to be a multi-channel preferred outcome and may be employed as a best practice for all 20 channels (or at least a subset of the 20 channels).

After block 616, process 600 may return to a calling process to perform other actions.

Although process 600 is described with reference to content, embodiments are not so limited; but rather, process 600 may also be employed to determine a preferred outcome based on calculated depreciations for features of content, rather than calculated depreciations for the content itself. For example, at block 602, actions associated with a plurality of content with a selected feature may be monitored; at block 604, content with the selected feature that was first published based on a first outcome may be selected; at blocks 606 and 608, metrics may be determined for the first and second outcome for the selected feature and a first depreciation may be calculated; at block 610, content with the selected feature that was first published based on a second outcome may be selected; at blocks 612 and 614, metrics may be determined for the first and second outcome for the selected feature and a second depreciation may be calculated; and at block 616, a preferred outcome for the selected feature may be determined based on the calculated depreciations.

FIG. 7 illustrates a logical flow diagram generally showing one embodiment of a process for validating a playbook employed for a channel. Process 700 beings, after a start block, at block 702, where a playbook for a plurality of channels may be generated. In some embodiments, the playbook may be generated by employing embodiments described above. In other embodiments, the playbook may be randomly generated and/or manually generated. In at least one embodiment, the playbook may include a plurality of plays or “best practices” to employ with content for a plurality of channels. In at least one of various embodiments, the playbook may include a plurality of preferred contextual recommendations that may be employed with publishing content to a plurality of channels for distribution of content. For example, the playbook may include a play to include a photo with each piece of content published on any of the plurality of channels. However, embodiments are not so limited and other plays may be employed.

Process 700 proceeds to block 704, where the playbook may be employed for a plurality of content (new and/or republished content) for the plurality of channels. In some embodiments, each of the plurality of content may be published and/or otherwise provided to one or more of the plurality of channels based on at least one of the preferred contextual recommendations of the playbook. In some embodiments, each publication may include modifying a corresponding piece of content based on at least one of the preferred contextual recommendations. In some embodiments, a plurality of preferred contextual recommendations may be employed for content.

Process 700 continues at block 706, where at least one of the plurality of channels may be selected. In at least one embodiment, the channel may be randomly selected. In another embodiment, the channels may be selected in a predetermined order, such as alphabetical, chronological by creation date, chronological by number of subscribed users, or the like.

In any event, process 700 proceeds next to block 708, where a metric for each piece of content published to the selected channel may be determined. In some embodiments, the metric may be an indicator of success and/or performance of a piece of content. In various embodiments, the metric for each piece of content may be a numerical value, an n-tuple, a qualitative assessment, and/or an indicator of a success/impact/performance of the content.

In some embodiments, the metric for a given piece of content may be determined based on actions associated with the given piece of content. These actions may include, but are not limited to, a number of user clicks, a number of times users' share the content, a number of user comments, a time accessing the content and/or the containing channel, revenue obtained from advertising associated with the content (e.g., advertisements shown alongside the content), revenue obtained directly from the user, or the like. In at least one embodiment, the actions may be monitored and/or collected for a given period of time. However, embodiments are not so limited and other methods and/or algorithms for determining and/or calculating metrics for each piece of content published to the selected channel may be employed.

Process 700 continues next at block 710, where each preferred contextual recommendation associated with the published content may be determined. In some embodiments, each published content may include metadata that indicates the preferred contextual recommendations (or plays) employed with the corresponding content. In other embodiments, a database may maintain identifiers of each piece of published content, the channel the content is published, the preferred contextual recommendations associated with the published content, or the like.

Process 700 proceeds to block 712, where a metric for each determined preferred contextual recommendation of the playbook may be determined for the selected channel. In various embodiments, the metrics determined for the published content may be translated into metrics for each preferred contextual recommendation. In at least one of various embodiments, the metric for each determined preferred contextual recommendation may be based on the metrics determined for each piece of published content. In some embodiments, the metric for a given preferred contextual recommendation may be an average (or other combination) of the metrics determined for each piece of content that employed the given preferred contextual recommendation. In other embodiments, the metric for a given preferred contextual recommendation may include a distribution of the metrics determined for each piece of content that employed the given preferred contextual recommendation. However, embodiments are not so limited and other algorithms and/or mechanisms may be employed to translate the content metrics into preferred contextual recommendation metrics.

In any event, process 700 proceeds to decision block 714, where a determination may be made whether a preferred contextual recommendation metric is below a threshold. In some embodiments, decision block 714 may be employed for each preferred contextual recommendation associated with the selected channel (i.e., each preferred contextual recommendation where a metric may be determined for the selected channel). In some embodiments, the threshold may be based on a statistical significance value. In other embodiments, the threshold may be determined by a publisher, editor, audience development staff, marketing team, or the like.

In some embodiments, comparison of a preferred contextual recommendation metric and the threshold value may be employed to determine if the preferred contextual recommendation metric is above or below the threshold value. In other embodiments, the preferred contextual recommendation metrics may be compared with each other. In at least one such embodiment, the preferred contextual recommendation metrics may be ranked from a lowest performing preferred contextual recommendation (e.g., a preferred contextual recommendation with a lowest average number of clicks per hour metric compared with the other preferred contextual recommendation metrics for the selected channel) to a highest performing preferred contextual recommendation (e.g., a preferred contextual recommendation with a highest average number of clicks per hour metric compared with the other preferred contextual recommendation metrics for the selected channel).

In at least one of various embodiments, a number of preferred contextual recommendations with the lowest metrics (e.g., lowest two preferred contextual recommendation metrics) may be determined to be below the threshold. For example, assume there are 10 preferred contextual recommendations that are ranked according to their corresponding determined metrics. In this example, the two preferred contextual recommendation with the lowest ranking of the 10 preferred contextual recommendations may be below the threshold. However, embodiments are not so limited and other mechanisms may be employed to determine if a preferred contextual recommendation metric is below a threshold. If a preferred contextual recommendation metric is below the threshold, then process 700 may flow to block 716 for that corresponding preferred contextual recommendation; otherwise, process 700 may flow to decision block 718.

At block 716, the playbook for the selected channel may be modified based on the determined metrics that are below (or above) the threshold. In some embodiments, each preferred contextual recommendation that has a metric below the threshold may be removed from the playbook for the selected channel. In at least one embodiment, removing a preferred contextual recommendation from the playbook may include deleting and/or prohibiting the preferred contextual recommendation from being employed with a piece of content for the selected channel and/or from being recommended to an editor/publisher for employment. By removing preferred contextual recommendations from the selected channel, unsuccessful or ineffective preferred contextual recommendations may not be employed for the selected channel. In some embodiments, a test may be employed as described herein to determine if a removed preferred contextual recommendation may be later re-added to the playbook. After block 716, process 700 may flow to decision block 718

If, at decision block 714, a preferred contextual recommendation metric is not below the threshold, then process 700 may proceed to decision block 718. In some embodiments, each preferred contextual recommendation of the selected channel may flow from decision block 714 to 718, either directly (if preferred contextual recommendation metric is above the threshold) or through block 716 (if preferred contextual recommendation metric is below the threshold).

At decision block 718, a determination may be made whether to select another channel or not. In some embodiments, each of the plurality of channels may be selected, such that preferred contextual recommendation metrics may be determined for each channel. If another channel may be selected, then process 700 may loop to block 706 to select another channel; otherwise, process 700 may return to a calling process to perform other actions.

Although process 700 is described with reference to content, embodiments are not so limited; but rather, process 700 may also be employed for features of content. For example, process 700 may determine preferred contextual recommendations for a selected channel based on determined metrics of features of content published to the selected channel—which may enable the playbook of a channel to be modified based on a success of features, rather than on a success of content.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

The above specification, examples, and data provide a complete description of the composition, manufacture, and use of the invention. Since many embodiments of the invention can be made without departing from the spirit and scope of the invention, the invention resides in the claims hereinafter appended.

1. A method for providing content to a plurality of users over a network, wherein at least one network device performs actions, comprising:
selecting a plurality of content to be provided to the plurality of users through a channel for distribution;
determining a test for a variable having at least a first outcome and a second outcome, wherein each outcome corresponds to a different contextual recommendation to employ with the plurality of content;
determining, for each of the plurality of content, an order for employing the first outcome and the second outcome for a plurality of publications;
publishing each of the plurality of content to the channel at least twice based on the determined order, wherein a publication for each content to the channel is also based on a contextual recommendation corresponding to the first outcome and another publication for each content to the channel is also based on another contextual recommendation corresponding to the second outcome; and
selecting a preferred outcome that corresponds to either the first outcome or the second outcome based on at least user actions associated with at least both publications of each of the plurality of content.

2. The method of claim 1, wherein a first publication of content occurs at a time prior to a second publication of the same content.

3. The method of claim 1, wherein a portion of the plurality of content is initially published based on the contextual recommendation and later republished based on the other contextual recommendation, and a separate portion of the selected content is initially published based on the other contextual recommendation and later republished based on the contextual recommendation.

4. The method of claim 1, further comprising:
modifying a portion of the plurality of content based on the contextual recommendation for a first publication of the portion of the plurality of content, and
modifying the portion of the plurality of content based on the other contextual recommendation for a second publication of the portion of the plurality of content, wherein the second publication is enabled to occur at a time after the first publication occurs.

5. The method of claim 1, wherein determining the preferred outcome further includes determining a depreciation of user actions associated with a first publication of the plurality of content and other user actions associated with a second publication of the plurality of content.

6. The method of claim 1, further comprising:
performing the actions of claim 1 for each of a subset of a plurality of channels for distribution; and
determining a multi-channel preferred outcome for the plurality of channels based on preferred outcomes separately determined for each of the subset of channels.

7. The method of claim 1, further comprising:
determining a metric for each of a plurality of preferred contextual recommendations employed for publishing other content to each of a plurality of channels; and
employing each preferred contextual recommendation that corresponds to a metric of a corresponding channel that is above a threshold for publication of other content to corresponding channel.

8. The method of claim 1, further comprising:
publishing other content to a plurality of channels for distribution based on at least one of a plurality of preferred contextual recommendations; and
for each given channel of the plurality of channels:
determining a metric for each of a plurality of preferred contextual recommendations employed for publishing the other content to the given channel; and
modifying the plurality of contextual recommendations for the given channel based on the determined metrics that are above a threshold.

9. A system for providing content to a plurality of users over a network, comprising:
at least one network device, comprising:
a memory or storing data and instructions;
a processor that executes the instructions to enable actions, comprising:
selecting a plurality of content to be provided to the plurality of users through a channel for distribution;
determining a test for a variable having at least a first outcome and a second outcome, wherein each outcome corresponds to a different contextual recommendation to employ with the plurality of content;
determining, for each of the plurality of content, an order for employing the first outcome and the second outcome for a plurality of publications;
publishing each of the plurality of content to the channel at least twice based on the determined order, wherein a publication for each content to the channel is also based on a contextual recommendation corresponding to the first outcome and another publication for each content to the channel is also based on another contextual recommendation corresponding to the second outcome; and
selecting a preferred outcome that corresponds to either the first outcome or the second outcome based on at least user actions associated with at least both publications of each of the plurality of content.

10. The system of claim 9, wherein a first publication of content occurs at a time prior to a second publication of the same content.

11. The system of claim 9, wherein a portion of the plurality of content is initially published based on the contextual recommendation and later republished based on the other contextual recommendation, and a separate portion of the selected content is initially published based on the other contextual recommendation and later republished based on the contextual recommendation.

12. The system of claim 9, further comprising:
modifying a portion of the plurality of content based on the contextual recommendation for a first publication of the portion of the plurality of content, and
modifying the portion of the plurality of content based on the other contextual recommendation for a second publication of the portion of the plurality of content, wherein the second publication is enabled to occur at a time after the first publication occurs.

13. The system of claim 9, wherein determining the preferred outcome further includes determining a depreciation of user actions associated with a first publication of the plurality of content and other user actions associated with a second publication of the plurality of content.

14. The system of claim 9, further comprising:
performing the actions of claim 9 for each of a subset of a plurality of channels for distribution; and
determining a multi-channel preferred outcome for the plurality of channels based on preferred outcomes separately determined for each of the subset of channels.

15. The system of claim 9, further comprising:
determining a metric for each of a plurality of preferred contextual recommendations employed for publishing other content to each of a plurality of channels; and
employing each preferred contextual recommendation that corresponds to a metric of a corresponding channel that is above a threshold for publication of other content to corresponding channel.

16. The system of claim 9, further comprising:
publishing other content to a plurality of channels for distribution based on at least one of a plurality of preferred contextual recommendations; and
for each given channel of the plurality of channels:
determining a metric for each of a plurality of preferred contextual recommendations employed for publishing the other content to the given channel; and
modifying the plurality of contextual recommendations for the given channel based on the determined metrics that are above a threshold.

17. A processor readable non-transitory storage media that includes instructions for providing content to a plurality of users over a network, wherein the execution of the instructions by a processor enables actions, comprising:
selecting a plurality of content to be provided to the plurality of users through a channel for distribution;
determining a test for a variable having at least a first outcome and a second outcome, wherein each outcome corresponds to a different contextual recommendation to employ with the plurality of content;
determining, for each of the plurality of content, an order for employing the first outcome and the second outcome for a plurality of publications;
publishing each of the plurality of content to the channel at least twice based on the determined order, wherein a publication for each content to the channel is also based on a contextual recommendation corresponding to the first outcome and another publication for each content to the channel is also based on another contextual recommendation corresponding to the second outcome; and
selecting a preferred outcome that corresponds to either the first outcome or the second outcome based on at least user actions associated with at least both publications of each of the plurality of content.

18. The media of claim 17, wherein a first publication of content occurs at a time prior to a second publication of the same content.

19. The media of claim 17, wherein a portion of the plurality of content is initially published based on the contextual recommendation and later republished based on the other contextual recommendation, and a separate portion of the selected content is initially published based on the other contextual recommendation and later republished based on the contextual recommendation.

20. The media of claim 17, further comprising:
modifying a portion of the plurality of content based on the contextual recommendation for a first publication of the portion of the plurality of content, and
modifying the portion of the plurality of content based on the other contextual recommendation for a second publication of the portion of the plurality of content, wherein the second publication is enabled to occur at a time after the first publication occurs.

21. The media of claim 17, wherein determining the preferred outcome further includes determining a depreciation of user actions associated with a first publication of the plurality of content and other user actions associated with a second publication of the plurality of content.

22. The media of claim 17, further comprising:
performing the actions of claim 17 for each of a subset of a plurality of channels for distribution; and
determining a multi-channel preferred outcome for the plurality of channels based on preferred outcomes separately determined for each of the subset of channels.

23. The media of claim 17, further comprising:
determining a metric for each of a plurality of preferred contextual recommendations employed for publishing other content to each of a plurality of channels; and
employing each preferred contextual recommendation that corresponds to a metric of a corresponding channel that is above a threshold for publication of other content to corresponding channel.

24. A computing device for providing content to a plurality of users over a network, comprising:
a memory for storing data and instructions; and
a processor that executes the instructions to enable actions, including:
selecting a plurality of content to be provided to the plurality of users through a channel for distribution;
determining a test for a variable having at least a first outcome and a second outcome, wherein each outcome corresponds to a different contextual recommendation to employ with the plurality of content;
determining, for each of the plurality of content, an order for employing the first outcome and the second outcome for a plurality of publications;
publishing each of the plurality of content to the channel at least twice based on the determined order, wherein a publication for each content to the channel is also based on a contextual recommendation corresponding to the first outcome and another publication for each content to the channel is also based on another contextual recommendation corresponding to the second outcome; and
selecting a preferred outcome that corresponds to either the first outcome or the second outcome based on at least user actions associated with at least both publications of each of the plurality of content.

25. The computing device of claim 24, wherein a first publication of content occurs at a time prior to a second publication of the same content.

26. The computing device of claim 24, wherein a portion of the plurality of content is initially published based on the contextual recommendation and later republished based on the other contextual recommendation, and a separate portion of the selected content is initially published based on the other contextual recommendation and later republished based on the contextual recommendation.

27. The computing device of claim 24, further comprising:
modifying a portion of the plurality of content based on the contextual recommendation for a first publication of the portion of the plurality of content, and
modifying the portion of the plurality of content based on the other contextual recommendation for a second publication of the portion of the plurality of content, wherein the second publication is enabled to occur at a time after the first publication occurs.

28. The computing device of claim 24, wherein determining the preferred outcome further includes determining a depreciation of user actions associated with a first publication of the plurality of content and other user actions associated with a second publication of the plurality of content.

29. The computing device of claim 24, further comprising:
performing the actions of claim 24 for each of a subset of a plurality of channels for distribution; and
determining a multi-channel preferred outcome for the plurality of channels based on preferred outcomes separately determined for each of the subset of channels.

30. The computing device of claim 24, further comprising:
determining a metric for each of a plurality of preferred contextual recommendations employed for publishing other content to each of a plurality of channels; and
employing each preferred contextual recommendation that corresponds to a metric of a corresponding channel that is above a threshold for publication of other content to corresponding channel.
